(19) United States
(12) Patent Application Publication
(10) Pub. No.: US 2016/0127066 A1
(43) Pub. Date: May 5, 2016

(54) RELATIVE CLOCK DRIFT CALIBRATION FOR CHANNEL STITCHING

(71) Applicant: QUALCOMM Incorporated, San Diego, CA (US)

(72) Inventors: Jubin Jose, Bound Brook, NJ (US); Thomas Joseph Richardson, South Orange, NJ (US); Xinzhou Wu, Hillsborough, NJ (US); Shrinivas Shrikant Kudekar, Somerville, NJ (US)

(21) Appl. No.: 14/531,190

(22) Filed: Nov. 3, 2014

(51) Int. Cl. H04J 3/06; H04W 28/20; H04B 17/21; H04L 12/841

(52) U.S. Cl. CPC H04J 3/0658; H04L 47/283; H04W 28/20; H04B 17/21

(57) ABSTRACT

Techniques and systems described herein provide for improved clock drift calibration of two or more clocks of two or more wireless devices. According to one example method, a first packet is received at a first wireless device from a second wireless device sent at a first time. The method may also include determining a first time-of-arrival estimate for the first packet. The method may further include receiving, at the first wireless device, a second packet from the second wireless device sent at a second time. The method may also include determining a second time-of-arrival estimate for the second packet and determining a relative clock drift between the first wireless device and the second wireless device based at least in part on the first time-of-arrival estimate and the second time-of-arrival estimate.

### BACKGROUND

The following relates generally to wireless communication, and more specifically to determining a relative clock drift between two wireless devices. Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, bandwidth, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems used commonly for communication in Cellular networks, Wi-Fi networks, and the like.

Time-of-arrival (ToA) estimation can be a physical-layer measurement that may be used to obtain range/pseudo-range estimates between two wireless devices. Identified used-cases for range/pseudo-range estimates include indoor positioning and peer-to-peer (P2P) ranging. Inaccurate clock measurements due to two different wireless devices having clocks that are not reading the same time simultaneously may lead to inaccurate ranging. Other measurements made using misaligned clocks may reflect similar inaccuracies.

### SUMMARY

Techniques described herein may determine an estimated relative clock drift between two different clocks of two different devices. Using two data packets with as similar conditions as possible (e.g., transmitted on same frequency, same payload, etc.) sent at two different times, wireless devices using techniques described herein may determine the estimated relative clock drift. The estimated relative clock drift may be used to calibrate the clocks of the two different devices. With calibrated clocks, measurements or techniques may be improved with the aligned time readings of the two clocks.

In a first set of illustrative examples, a method for wireless communication is described. In one configuration, the method includes receiving, at a first wireless device, a first packet from a second wireless device sent at a first time and determining a first time-of-arrival estimate for the first packet. The method may also include receiving, at the first wireless device, a second packet from the second wireless device sent at a second time and determining a second time-of-arrival estimate for the second packet. The method may further include determining a relative clock drift between the first wireless device and the second wireless device based at least in part on the first time-of-arrival estimate and the second time-of-arrival estimate.

In some examples, the method may also include transmitting, by the first wireless device, the relative clock drift to the second wireless device. In some examples, the method may further include receiving, at the first wireless device, a first time-of-departure (TOD) for the first packet as determined by the second wireless device and receiving, at the first wireless device, a second TOD for the second packet as determined by the second wireless device. Determining the relative clock drift may be further based at least in part on the first TOD and the second TOD.

In some examples of the method, determining the relative clock drift further includes aligning the first time-of-arrival estimate with the second time-of-arrival estimate. In some examples, aligning the first time-of-arrival estimate and the second time-of-arrival estimate further includes performing at least one of a time correlation between the first packet and the second packet and a slope estimation between two different long training field symbols between the first wireless device and the second wireless device.

The method may include, in some examples, performing, by the first wireless device, multiple round trip time (RTT) packet exchanges with the second wireless device over different channels of a bandwidth and determining channel frequency responses for each of the RTT packet exchanges. Such examples may also include stitching together the channel frequency responses and determining a bandwidth channel frequency response for the bandwidth based at least in part on the stitched channel frequency responses and the relative clock drift.

In some examples, the method includes determining a distance between the first wireless device and the second wireless device based at least in part on a transmission time of a data packet between the first wireless device and the second wireless device and the relative clock drift. In some examples, the first packet and the second packet are received on a same frequency. The first wireless device may be limited to a maximum bandwidth in some examples.

In some examples of the method, the relative clock drift may be a first relative clock drift, and the method may include receiving, at the first wireless device, a third time-of-arrival estimate from a third wireless device, wherein the third time-of-arrival estimate is for the third wireless device receiving the first packet. The method may also include receiving, at the first wireless device, a fourth time-of-arrival estimate from the third wireless device, wherein the fourth time-of-arrival estimate is for the third wireless device receiving the second packet. The method may further include determining a second relative clock drift between the first wireless device and the third wireless device based at least in part on the third time-of-arrival estimate and the fourth time-of-arrival estimate. In some examples, the method includes calibrating a clock difference between the second wireless device and the third wireless device based at least in part on the second relative clock drift and the first relative clock drift

In a second set of illustrative examples, an apparatus for wireless communication is described. In one configuration, the apparatus may include means for receiving, at a first wireless device, a first packet from a second wireless device sent at a first time and means for determining a first time-of-arrival estimate for the first packet. The apparatus may also include means for receiving, at the first wireless device, a second packet from the second wireless device sent at a second time and means for determining a second time-of-arrival estimate for the second packet. The apparatus may include means for determining a relative clock drift between the first wireless device and the second wireless device based at least in part on the first time-of-arrival estimate and the second time-of-arrival estimate.

In a third set of illustrative examples, another apparatus for wireless communication is described. In one configuration, the apparatus may include a receiver to receive a first packet from a wireless device sent at a first time and a second packet from the wireless device sent at a second time. The apparatus may also include a time-of-arrival estimator to determine a first time-of-arrival estimate for the first packet and a second time-of-arrival estimate for the second packet. The apparatus may also include a calibrator to determine a relative clock drift between the first wireless device and the second wireless device based at least in part on the first time-of-arrival estimate and the second time-of-arrival estimate.

In a fourth set of illustrative examples, a non-transitory computer-readable medium storing computer-executable code for wireless communication is described. In one configuration, the non-transitory computer-readable medium may include code for wireless communication executable by a processor to cause the wireless communication apparatus to receive, at a first wireless device, a first packet from a second wireless device sent at a first time and determine a first time-of-arrival estimate for the first packet. The code may also be executable by the processor to receive, at the first wireless device, a second packet from the second wireless device sent at a second time and determine a second time-of-arrival estimate for the second packet. The code may also be executable by the processor to determine a relative clock drift between the first wireless device and the second wireless device based at least in part on the first time-of-arrival estimate and the second time-of-arrival estimate.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communication system, in accordance with various aspects of the present disclosure;

FIG. 2 shows a block diagram of a wireless communication system performing a clock drift calibration, in accordance with various aspects of the present disclosure;

FIG. 3 shows a flow diagram of an example process of performing a clock drift calibration, in accordance with various aspects of the present disclosure;

FIG. 4 shows a flow diagram of another example process of performing a clock drift calibration, in accordance with various aspects of the present disclosure;

FIG. 5 shows a flow diagram of an example process of channel stitching, in accordance with various aspects of the present disclosure;

FIG. 6 shows a block diagram of an example of an apparatus for use in an AP for wireless communication, in accordance with various aspects of the present disclosure;

FIG. 7 shows a block diagram of another example of a wireless communications device for use in an AP for wireless communication, in accordance with various aspects of the present disclosure;

FIG. 8 shows a block diagram of an access point for use in wireless communication, in accordance with various aspects of the present disclosure;

FIG. 9 shows a block diagram of another example of an apparatus for use in wireless communication, in accordance with various aspects of the present disclosure;

FIG. 10 shows a block diagram of yet another example of an apparatus for use in wireless communication, in accordance with various aspects of the present disclosure;

FIG. 11 shows a block diagram of a wireless device for use in wireless communication, in accordance with various aspects of the present disclosure;

FIG. 12 is a flowchart of a method for wireless communication, in accordance with various aspects of the present disclosure;

FIG. 13 is a flowchart of a method for clock calibration using information for received data packets, in accordance with various aspects of the present disclosure; and

FIG. 14 is a flowchart of a method for clock calibration for a wireless device that sent data packets, in accordance with various aspects of the present disclosure.

### DETAILED DESCRIPTION

Two wireless devices may exchange data packets. However, those two wireless devices may each have their own clocks and take time measurements according to their individual clock. These clocks may not read the same values nor have the same time differences. That is, the clocks may have a relative clock drift between them. Techniques described herein provide for an improved estimated relative clock drift that can be used to calibrate one or both clocks of the two wireless devices. For some measurements or techniques, accurate readings of both clocks may be needed for accurate measurements or so that the techniques perform with a threshold accuracy level. An example measurement may include a ranging or pseudo-ranging estimate that determines a physical distance between the two wireless devices. A technique that can be improved with more accurate time readings includes channel stitching.

A first wireless device may send two identical data packets on a same frequency to a second wireless device. The second wireless device may have a clock that reads differently than a clock of the first wireless device. Without knowing when the two data packets arrived at the second wireless device according to the clock of the first wireless device, the second wireless device can determine a relative clock drift between the two clocks based on timing information related to the two data packets.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

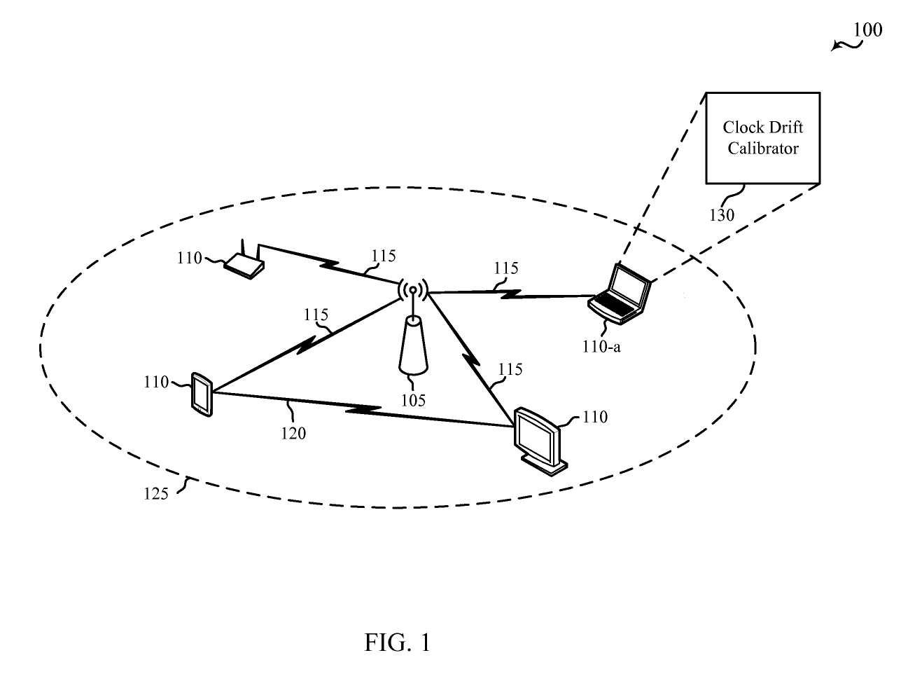

Referring first to FIG. 1, a block diagram illustrates an example of a WLAN network 100 such as, e.g., a network implementing at least one of the IEEE 802.11 family of standards. The WLAN network 100 may include an access point (AP) 105 and wireless devices or stations (STAs) 110, such as mobile stations, personal digital assistants (PDAs), other handheld devices, netbooks, notebook computers, tablet computers, laptops, display devices (e.g., TVs, computer monitors, etc.), printers, and the like. While only one AP 105 is illustrated in FIG. 1, the WLAN network 100 may have multiple APs 105. Each of the wireless devices 110, which may also be referred to as mobile stations (MSs), mobile devices, access terminals (ATs), user equipment (UE), subscriber stations (SSs), or subscriber units, may associate and communicate with an AP 105 via a communication link 115. Each AP 105 has a geographic coverage area 125 such that wireless devices 110 within the area 125 can typically communicate with the AP 105. The wireless devices 110 may be dispersed throughout the geographic coverage area 125. Each wireless device 110 may be stationary or mobile.

In some examples, a wireless device 110 can be covered by more than one AP 105 and can therefore associate with APs 105 at different times. A single AP 105 and an associated set of stations 110 may be referred to as a basic service set (BSS). An extended service set (ESS) can be a set of connected BSSs. A distribution system (DS) can be used to connect APs 105 in an extended service set. A geographic coverage area 125 for an access point 105 may be divided into sectors making up only a portion of the coverage area 125. The WLAN network 100 may include access points 105 of different types (e.g., metropolitan area, home network, etc.), with varying sizes of coverage areas and overlapping coverage areas for different technologies. Other wireless devices may also communicate with the AP 105.

While the wireless devices 110 may communicate with each other through the AP 105 using communication links 115, each wireless device 110 may also communicate directly with other wireless devices 110 via a direct wireless link 120. Two or more wireless devices 110 may communicate via a direct wireless link 120 when both wireless devices 110 are in the AP geographic coverage area 125 or when one or neither wireless device 110 is within the AP geographic coverage area 125. Examples of direct wireless links 120 may include Wi-Fi Direct connections, connections established by using a Wi-Fi Tunneled Direct Link Setup (TDLS) link, and other P2P group connections. The wireless devices 110 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, and the like. In other implementations, other peer-to-peer connections and/or ad hoc networks may be implemented within WLAN network 100.

The wireless devices 110 and/or the AP 105 may be able to perform clock drift calibrations relative to another wireless device and/or AP. As shown in FIG. 1, a wireless device 110-a includes a clock drift calibrator 130. The clock drift calibrator 130 may use information from packets received from another wireless device 110 and/or the AP 105 to determine a value of a clock drift between the wireless device 110-a and the device that sent the packets (i.e., the other wireless device 110 and/or the AP 105). In particular, the clock drift calibrator 130 estimate a time-of-arrival of two packets received at the wireless device 110-a to determine the relative clock drift. The relative clock drift may be used to adjust a clock of the wireless device 110-a. In other examples, the relative clock drift may be used in order to improve the accuracy of measurements that use time as a component, such as range and/or pseudo-range estimates including indoor positioning and peer-to-peer ranging.

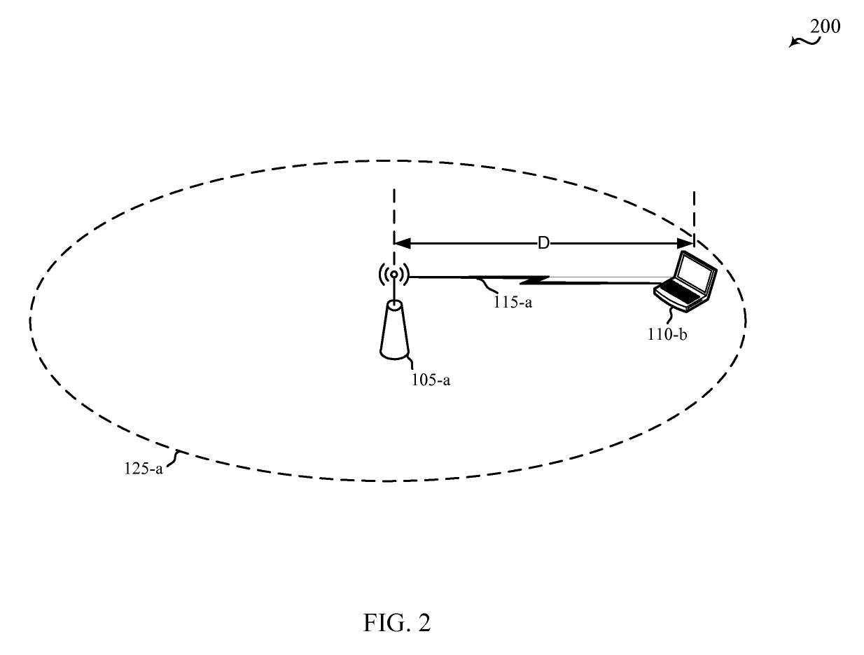

FIG. 2 shows a block diagram of a wireless communication system 200 performing a clock drift calibration, in accordance with various aspects of the present disclosure. The wireless communication system 200 includes an AP 105-a and a wireless device 110-b. The AP 105-a may be an example of aspects of the APs 105 described with reference to FIG. 1. Likewise, the wireless device 110-b may be an example of aspects of the wireless devices 110 described with reference to FIG. 1.

In the example of FIG. 2, the AP 105-a and the wireless device 110-b may perform a clock drift calibration. One of the AP 105-a or the wireless device 110-b may send packets to the other, and the other may use timing information relating to the packets to determine a relative clock drift. As described herein for explanatory purposes, the wireless device 110-b may transmit two data packets to the AP 105-a and the AP 105-a determines the clock drift calibration. In other examples, the AP 105-a may transmit two data packets to the wireless device 110-b and the wireless device 110-b determines the clock drift calibration.

The wireless device 110-b may send a first data packet with a time-of-departure TOD₁ and a second data packet over a communication link 115-a with a time-of-departure TOD₂. The communication link 115-a may be wireless or wired. As used herein, a time-of-departure can be a time that the device transmits a packet according to a clock of the device. The clock of the device may be a local clock for the device or an external clock. Thus, for example, the time-of-departure TOD₁ for the wireless device 110-a sending the first data packet will be the time a clock associated with the wireless device 110-a transmits the first data packet.

The AP 105-a may estimate a time-of-arrival t₁ for the first data packet and a time-of-arrival t₂ for the second data packet. The actual time-of-arrival for the first data packet is TOA₁, according to the clock of the wireless device 110-b. Likewise, the actual time-of-arrival for the second data packet is TOA₂, according to the clock of the wireless device 110-b. As used herein, a time-of-arrival can be a time that the device receives a packet according to a clock of the device. That is, a time-of-arrival is a time for when a packet receiving event occurs. The clock of a device may be a local clock for the device or an external clock. Thus, for example, the actual time-of-arrival TOA₁ for the AP 105-a receiving the first data packet will be the time a clock associated with the wireless device 110-b receives the first data packet. Likewise, the estimated time-of-arrival t₁ for the AP 105-a receiving the first data packet will be the time the AP 105-a determines it received the first data packet according to a clock of the AP 105-a.

Using the estimated time-of-arrival for both packets, the AP 105-a may determine a relative clock drift of the AP 105-a with respect to the wireless device 110-b. The AP 105-a may provide information relating to the relative clock drift to the wireless device 110-b.

The relative clock drift can be used to correct a time offset between the two devices and/or a phase slope. The relative clock drift can also be used to improve range estimates. As shown in FIG. 2, a distance, D, separating the AP 105-a and the wireless device 110-b may be determined using ranging techniques. Knowing the relative clock drift and compensating for the clock drift can improve accuracy of a range determination. The clock drift techniques described herein may work for both line-of-sight (LOS) and non-line-of-sight (NLOS) scenarios.

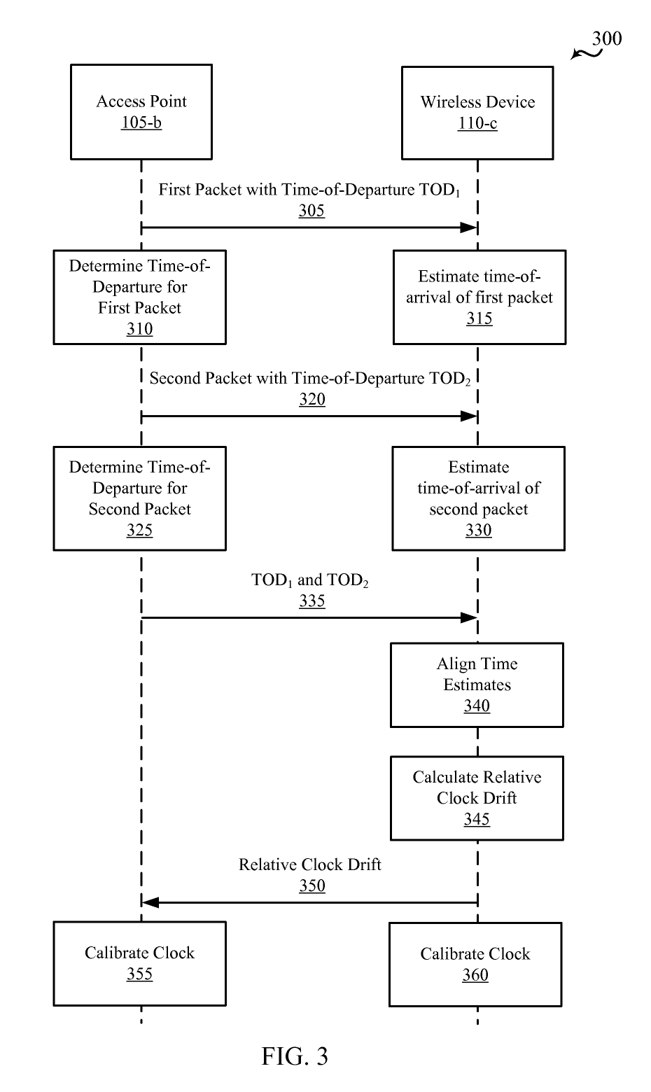

FIG. 3 shows a flow diagram of an example process 300 of performing a clock drift calibration, in accordance with various aspects of the present disclosure. In this example, an AP 105-b sends at least two data packets to a wireless device 110-c. The AP 105-b may be an example of aspects of the APs 105 described with reference to FIGS. 1 and 2. Likewise, the wireless device 110-c may be an example of aspects of the wireless devices 110 described with reference to FIGS. 1 and 2. Although FIG. 3 illustrates the process 300 being performed between an AP and a wireless device, the process 300 may be performed between two or more APs and two or more wireless devices, or a combination thereof

The AP 105-b may transmit a first packet 305 having a time-of-departure TOD₁ to the wireless device 110-c. The AP 105-b may determine the time-of-departure TOD₁ for the first packet at block 310. The AP 105-b may transmit a second packet 320 having a time-of-departure TOD₂ to the wireless device 110-c. The AP 105-b may determine the time-of-departure TOD₂ for the second packet at block 325. In some examples, the AP 105-b knows TOD₁ and TOD₂ a priori due to the AP 105-b scheduling when to transmit the data packets. In other examples, the AP 105-b records a time of a clock associated with the AP 105-b at when the AP 105-b transmits the data packets.

The wireless device 110-c may estimate a time-of-arrival, t₁, for the first data packet at block 315. The wireless device 110-c may estimate t₁ by reading the time according to a clock of the wireless device 110-c when the wireless device 110-c receives the first data packet. The wireless device 110-c may also estimate a time-of-arrival, t₂, for the second data packet at block 330. Similarly, the wireless device 110-c may estimate t₂ by reading the time according to a clock of the wireless device 110-c when the wireless device 110-c receives the second data packet.

In some examples, the AP 105-b may transmit a message 335 identifying the time-of-departures TOD₁ and TOD₂ to the wireless device 110-c. The TOD₁ and TOD₂ may be sent in a combined message or in a separate message. Alternatively, the TOD₁ and TOD₂ may be identified and transmitted to the wireless device 110-c along with the first and second data packets, respectively.

At block 340, the wireless device 110-c may align the time estimates t₁ and t₂. The wireless device 110-c, using a clock drift calibrator such as the clock drift calibrator 130 of FIG. 1, may perform an alignment in several different ways. For example, the wireless device 110-c may perform a time correlation of the received time samples corresponding to the first and second data packets. In another example, the wireless device 110-c may perform a slope estimation on the different of two long training fields (LTFs).

The wireless device 110-c may calculate a relative clock drift between the wireless device 110-c and the AP 105-b at block 345. The wireless device 110-c may calculate the relative clock drift using the estimated time-of-arrival values and the time-of-departure values. Responsive to determining the relative clock drift, the wireless device 110-c may transmit the relative clock drift to the AP 105-b. The AP 105-b may calibrate its clock at block 355 using the relative clock drift. The wireless device 110-c may calibrate its clock at block 360 according to the relative clock drift. In some examples, only one or the other of the AP 105-b and the wireless device 110-c calibrates its clock according to the relative clock drift. In calibrating a clock, a device may adjust the clock to match a clock of another device. For example, the wireless device 110-c may, using the relative clock drift, calibrate its clock to match the clock of the AP 105-b. This may accurately correct any time offset between the wireless device 110-c and the AP 105-b which may improve several techniques, such as ranging and channel stitching.

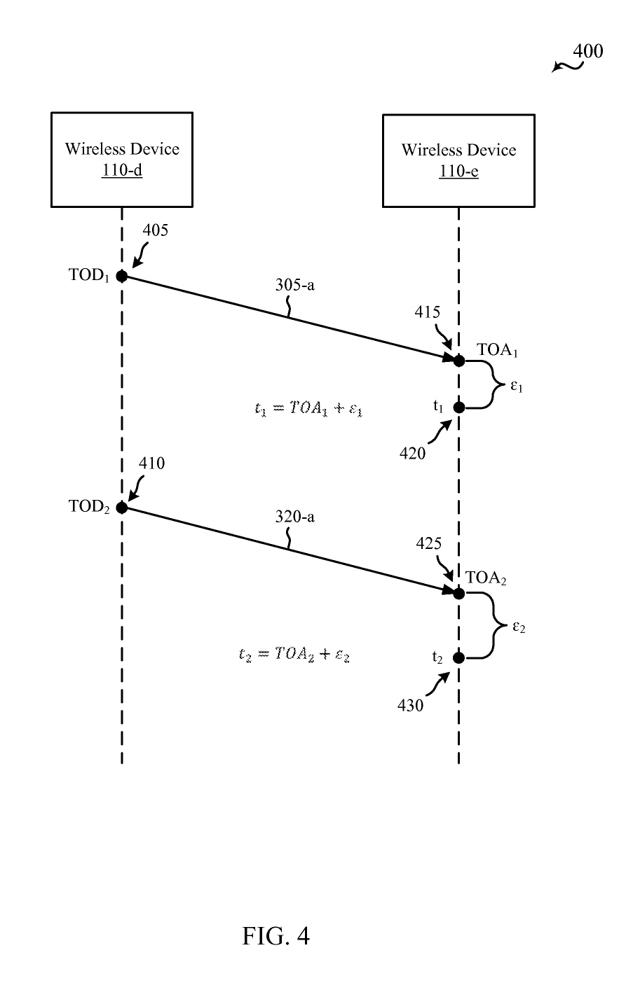

FIG. 4 shows a flow diagram of another example process 400 of performing a clock drift calibration, in accordance with various aspects of the present disclosure. The process 400 illustrates an example clock drift calibration between a wireless device 110-d and another wireless device 110-e. The wireless devices 110-d and 110-e may be examples of aspects of the wireless devices 110 described with reference to FIGS. 1-3. Although FIG. 4 illustrates the process 400 being performed between two wireless devices, the process 400 may be performed between two or more APs and an AP and a wireless device.

At time 405, the wireless device 110-d may transmit a first packet 305-a with a timestamp TOD₁. The timestamp can be a time-of-departure for the first packet 305-a according to a clock of the wireless device 110-d. The wireless device 110-e may determine an estimated time-of-arrival of the first data packet, t₁, as being at time 420. The wireless device 110-e may actually receive the first packet 305-a at TOA₁ at time 415, according to a clock of the wireless device 110-d. The estimated time-of-arrival may be offset from the actual time-of-arrival. This offset may be denoted ε₁ and may be positive (i.e., if the estimated time-of-arrival is after the actual time-of-arrival) or negative (i.e., if the estimated time-of-arrival is before the actual time-of-arrival).

At time 410, the wireless device 110-d may transmit a second packet 320-a with a timestamp TOD₂. The timestamp can be a time-of-departure for the second packet 320-a according to a clock of the wireless device 110-d. The wireless device 110-e may determine an estimated time-of-arrival of the second data packet, t₂, as being at time 425. The wireless device 110-e may actually receive the second packet 320-a at TOA₂ at time 425, according to a clock of the wireless device 110-d. The estimated time-of-arrival may be offset from the actual time-of-arrival. The wireless device 110-e may not know the actual times-of-arrival TOA₁ and TOA₂. This offset may be denoted ε₂ and may also be positive or negative.

As used herein, the times 405, 410, 420, and 425 represent points in time. The wireless device 110-d may send the first packet 305-a and the second packet 320-a over the same frequency. The second data packet may be a duplicate of the first data packet. The offsets ε₁ and ε₂ may represent error in the time-of-arrival readings. At least some of the times 405, 410, 420, and 425 may have a fine resolution in order to improve accuracy.

For these time measurements, each wireless device 110 may use its own clock. The time measured using the clock at the wireless device 110-d may be denoted by t_{A}=(1+δ_{A})t+ω_{A}. The time measured using the clock at the wireless device 110-e may be denoted by t_{B}=(1+δ_{B})t+ω_{B}. In the previous equations, the variable t may be a “true-time,” which can be thought of as a time according to a third clock (e.g., from a global navigation satellite system, such as a global positioning system (GPS)). The variables ω_{A} and ω_{B} may be the offsets of the clocks, respectively. The variables δ_{A} and δ_{B} may be the clock drifts of the devices with respect to the true-time. The wireless device 110-e may perform calculations to accurately determine and calibrate the relative clock drift between the wireless device 110-e and the wireless device 110-d.

The wireless device 110-e may align time t₂ with time t₁ to obtain t′₂≈TOA₂+ε₁. The wireless device 110-e may perform this alignment even though it does not know the actual time-of-arrivals TOA₁ and TOA₂. Note that the error in t′₂ may be the same as the error in t₁. The alignment may be possible through different methods. One method may include performing a time correlation of the received time samples of TOA₁ and TOA₂. Another method may include performing a slope estimation on the different of two long training fields. A slope representation may be created using the two points in time. Further, an ML-type algorithm may be used in multipath scenarios. In other examples, other algorithms can be used as well.

The relative clock drift of the wireless device 110-e with respect to the wireless device 110-d may be given as

$$\frac{1 + {δ}_{B}}{1 + {δ}_{A}} .$$

The wireless device 110-e may determine the relative clock drift by subtracting the aligned time t₂ and time t₁ and dividing the difference by the difference of the times-of-departure. Thus, the relative clock drift of the wireless device 110-e with respect to the wireless device 110-d may be defined as

$$\frac{1 + {δ}_{B}}{1 + {δ}_{A}} = \frac{{t}_{2}^{′} - {t}_{1}}{{TOD}_{2} - {TOD}_{1}} .$$

The inverse of this equation gives the relative clock drift of the wireless device 110-d with respect to the wireless device 110-e.

The wireless device 110-e may transmit the relative clock drift to the wireless device 110-d. The accuracy of the relative clock drift estimation may improve with TOD₂−TOD₁. The maximum difference of TOD₂−TOD₁ may be limited by a channel coherence time. This may not be coupled to the packet transmissions used for channel transmission, which could be transmitted as close in time as possible for best performance. Since the first and second data packets are transmitted on the same frequency, the channel response and other filter responses are expected to be the same for both packets.

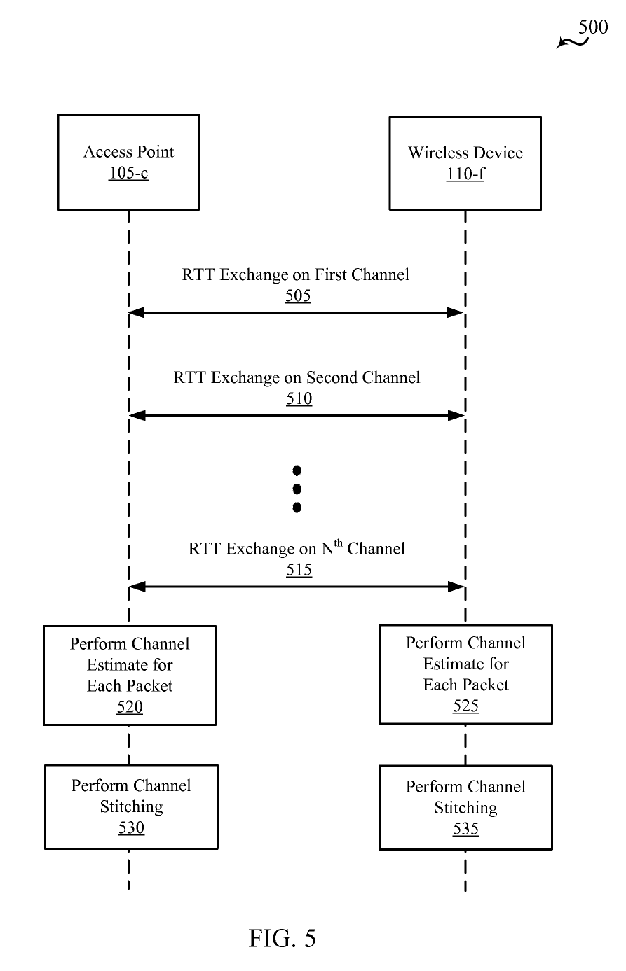

FIG. 5 shows a flow diagram of an example process of channel stitching, in accordance with various aspects of the present disclosure. The process 500 includes an AP 105-c and a wireless device 110-f The AP 105-c may be an example of aspects of the APs 105 described with reference to FIGS. 1-3. The wireless device 110-f may be an example of aspects of the wireless devices 110 described with reference to FIGS. 1-4.

Channel stitching is a technique used to obtain higher effective bandwidth despite hardware limitations of wireless devices. The hardware limitations may be, for example, maximum bandwidth limitations. Specifically, multiple round trip time (RTT) exchanges (e.g., exchanging data packets between two wireless devices) may be performed on different channels or frequencies. The channel frequency responses obtained from all these packets are coherently stitched to obtain a channel frequency response for the entire bandwidth.

In one example, the AP 105-c and the wireless device 110-f may communicate using a number of channels, denoted N. The AP 105-c and the wireless device 110-f may perform a first RTT exchange 505 on a first channel. The AP 105-c and the wireless device 110-f may perform a second RTT exchange 510 on a second channel. The second channel may be different than the first channel. The AP 105-c and the wireless device 110-f continue to perform RTT exchanges for each distinct channel up until, and including, an N^{th} RTT exchange 515 on an N^{th} channel. N may be any number of channels supported by the AP 105-c and the wireless device 110-f.

From each packet, the AP 105-c may perform a channel estimate at block 520. The channel estimate may be in the frequency domain. Likewise, the wireless device 110-f performs a channel estimate for each packet at block 525. Once the channel estimates are determined, the AP 105-c and the wireless device 110-f may perform channel stitching at blocks 530 and 535, respectively. In some examples, only one of the AP 105-c and the wireless device 110-f perform channel stitching. Channel stitching allows the multiple channel estimates to be put together into a coherent response. That is, the channel frequency responses obtained from all these packets are coherently stitched to obtain the channel frequency response for the entire bandwidth.

Channel stitching may be performed using the following equation:

$$h ( {f}_{2} + f , {t}_{1} ) = h ( {f}_{2} + f , {t}_{2} ) {e}^{- j f ( ( {t}_{2} - {t}_{1} ) - \frac{1 + {δ}_{B}}{1 + {δ}_{A}} ( {TOD}_{2} - {TOD}_{1} ) )} {e}^{jθ}$$

Each channel h according to the AP 105-c, having a frequency f₂+f, relates to the corresponding channel h according to the wireless device 110-f multiplied by a coefficient depending on the determined time offset. The variable j is the complex variable (e.g., \sqrt{−1}) and the variable θ may be an additional phase offset that may be present due to the radio frequency. The variable f₂ may represent a center frequency in a second channel and f may represent an offset from the center frequency to an actual frequency of a tone.

In one example, the AP 105-c and the wireless device 110-f may communicate using four channels. In this example, each data packet exchanged may be an 80 MHZ packet. Over time, the AP 105-c and/or the wireless device 110-f may scan multiple MHz of these channels. For example, 20 MHz may be scanned over 4 dimensions. These measurements may be combined to determine an accuracy of the combined bandwidth.

Even if the channel is within the coherence time, the channel frequency responses from different packets (in different time) may have different time offsets, which lead to different phase slopes. For channel stitching to work in practice, the time offset may be accurately corrected. Channel stitching may utilize the techniques of determining a relative clock drift as described herein. Channel stitching may lead to a coherent channel frequency response over a very large bandwidth. This coherent channel could be used to obtain improved time-of-arrival estimates.

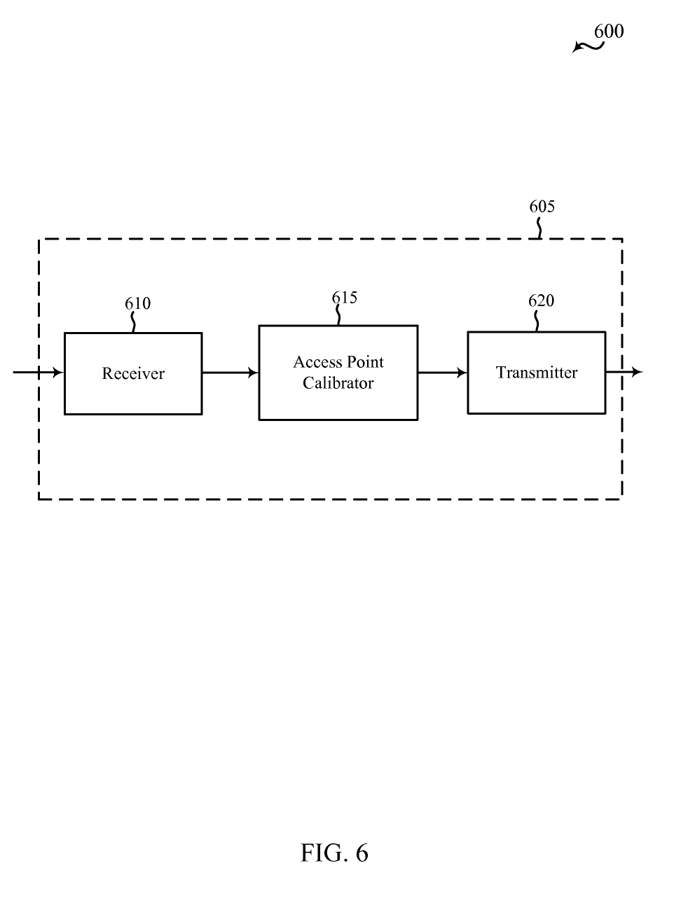

FIG. 6 shows a block diagram 600 of an example of an apparatus 605 for use in an AP for wireless communication, in accordance with various aspects of the present disclosure. The apparatus 605 may be an example of aspects of the APs 105 described with reference to FIGS. 1-3 and/or 5. The apparatus 605 may include a receiver 610, an access point calibrator 615, and/or a transmitter 620. The apparatus 605 may also be or include a processor. Each of these modules may be in communication with each other.

The apparatus 605, through the receiver 610, the access point calibrator 615, and/or the transmitter 620, may perform functions described herein. For example, the apparatus 605 may determine a relative clock drift between the apparatus 605 and another AP and/or wireless device.

The components of the apparatus 605 may, individually or collectively, be implemented using application-specific integrated circuits (ASICs) adapted to perform some or all of the applicable functions in hardware. Alternatively, the functions may be performed by other processing units (or cores), on integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each component may also be implemented, in whole or in part, with instructions embodied in a memory, formatted to be executed by general or application-specific processors.

The receiver 610 may receive information such as packets, user data, and/or control information associated with various information channels (e.g., control channels, data channels, etc.). The receiver 610 may receive two or more data packets, each having an identified time-of-departure. For example, the receiver 610 may receive two or more identical data packets, which may be on the same frequency. Additionally, the receiver 610 may receive RTT exchanges for use in channel stitching. Information may be passed on to the access point calibrator 615, and to other components of the apparatus 605.

The access point calibrator 615 may receive timing information for two identical data packets received at the receiver 610, including time-of-departure and an estimated time-of-arrival for each data packet. The data packets may be sent from a same device, such as a wireless device 110. The access point calibrator 615 may determine a relative clock drift between the apparatus 605 and the sending device. The access point calibrator 615 may provide the determined relative clock drift to the transmitter 620.

The transmitter 620 may transmit the signals received from other components of the apparatus 605. The transmitter 620 may transmit the determined relative clock drift to the sending device, such as a wireless device 110. In some examples, the transmitter 620 may be collocated with the receiver 610 in a transceiver module.

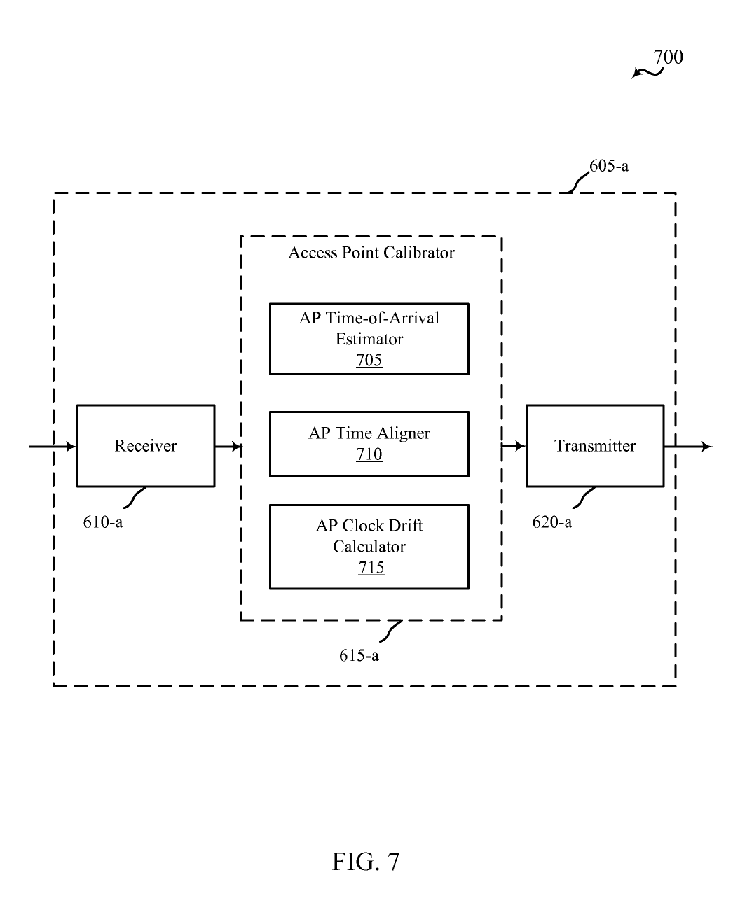

FIG. 7 shows a block diagram 700 of an apparatus 605-a that can be used in an AP for wireless communication, in accordance with various examples. The apparatus 605-a may be an example of aspects of an APs 105 described with reference to FIGS. 1-3 and/or 5. It may also be an example of an apparatus 605 described with reference to FIG. 6. The apparatus 605-a may include a receiver 610-a, an AP calibrator 615-a, and/or a transmitter 620-a, which may be examples of the corresponding modules of apparatus 605. The apparatus 605-a may also include a processor. Each of these modules may be in communication with each other. The AP calibrator 615-a may include an AP time-of-arrival estimator 705, an AP time aligner 710, and an AP clock drift calculator 715. The receiver 610-a and the transmitter 620-a may perform the functions of the receiver 610 and the transmitter 620, of FIG. 6, respectively.

The AP time-of-arrival estimator 705 may estimate a time-of-arrival for each data packet received at the apparatus 605-a. In some examples, the AP time-of-arrival estimator 705 only estimates the time-of-arrival for each data packet sent in a clock calibration process. For example, the AP time-of-arrival estimator 705 may determine a first time-of-arrival estimate for the first packet and a second time-of-arrival estimate for the second packet.

The AP time aligner 710 may align the estimated time-of-arrivals for the two data packets received at the receiver 610-a. That is, the AP time aligner 710 may perform a time correlation between the first packet and the second packet. For example, the AP time aligner 710 may perform a slope estimation between two different long training field symbols between the apparatus and the wireless device. The AP time aligner 710 may align the first time-of-arrival estimate with the second time-of-arrival estimate using the time correlation and the slope estimation.

The AP clock drift calculator 715 may determine a relative clock drift between the apparatus 605-a and the other wireless device based at least in part on the first time-of-arrival estimate and the second time-of-arrival estimate. In some examples, the wherein the AP clock drift calculator 715 may determine the relative clock drift based at least in part on the first TOD and the second TOD.

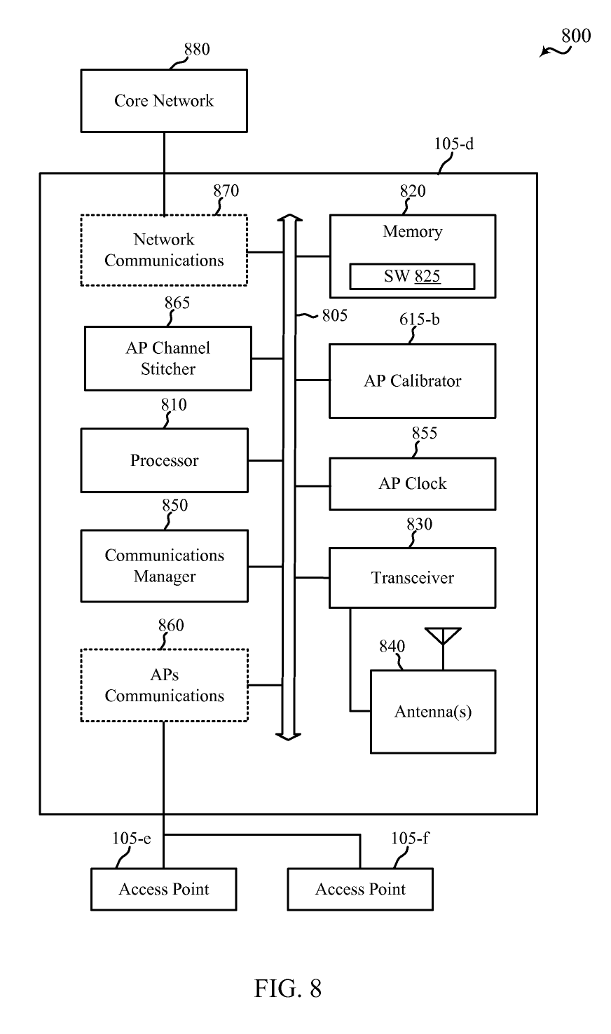

Turning to FIG. 8, a diagram 800 is shown that illustrates an access point or AP 105-d configured for accurately determining a relative clock drift. In some aspects, the AP 105-d may be an example of the APs 105 of FIGS. 1-3 and/or 5. The AP 105-d may include a processor 810, a memory 820, a transceiver 830, antennas 840, and an AP calibrator 615-b. The AP calibrator 615-b may be an example of the AP calibrator 615 of FIGS. 6 and/or 7. In some examples, the AP 105-d may also include one or both of an APs communications unit 860, a network communications unit 870, a communications manager 850, an AP clock 855, and an AP channel stitcher 865. Each of these modules may be in communication with each other, directly or indirectly, over at least one bus 805.

The memory 820 may include random access memory (RAM) and read-only memory (ROM). The memory 820 may also store computer-readable, computer-executable software (SW) code 825 containing instructions that, when executed, cause the processor 810 to perform various functions described herein for determining a clock drift between the AP clock 855 and a clock of another wireless device, for example. Alternatively, the software code 825 may not be directly executable by the processor 810 but may cause the computer, e.g., when compiled and executed, to perform functions described herein.

The processor 810 may include an intelligent hardware device, e.g., a central processing unit (CPU), a microcontroller, an ASIC, etc. The processor 810 may process information received through the transceiver 830, the APs communications unit 860, and/or the network communications unit 870. The processor 810 may also process information to be sent to the transceiver 830 for transmission through the antennas 840, to the APs communications unit 860, and/or to the network communications unit 870. The processor 810 may handle, alone or in connection with the AP calibrator 615-b, various aspects related to determining a relative clock drift and calibrating the AP clock 855. The processor 810 may also handle, alone or in connection with the AP channel stitcher 865, various aspects related to channel stitching.

The transceiver 830 may include a modem to modulate the packets and provide the modulated packets to the antennas 840 for transmission, and to demodulate packets received from the antennas 840. The transceiver 830 may be implemented as at least one transmitter module and at least one separate receiver module. The transceiver 830 may communicate bi-directionally, via the antennas 840, with at least one wireless device 110 as illustrated in FIGS. 1-3, for example. The AP 105-d may typically include multiple antennas 840 (e.g., an antenna array). The AP 105-d may communicate with a core network 880 through the network communications unit 870. The AP 105-d may communicate with other APs, such as the access point 105-e and the access point 105-f, using the APs communications unit 860.

According to the architecture of FIG. 8, the AP 105-d may further include a communications manager 850. The communications manager 850 may manage communications with stations and/or other devices as illustrated in the WLAN network 100 of FIG. 1. The communications manager 850 may be in communication with some or all of the other components of the AP 105-d via the bus or buses 805. Alternatively, functionality of the communications manager 850 may be implemented as a component of the transceiver 830, as a computer program product, and/or as at least one controller element of the processor 810.

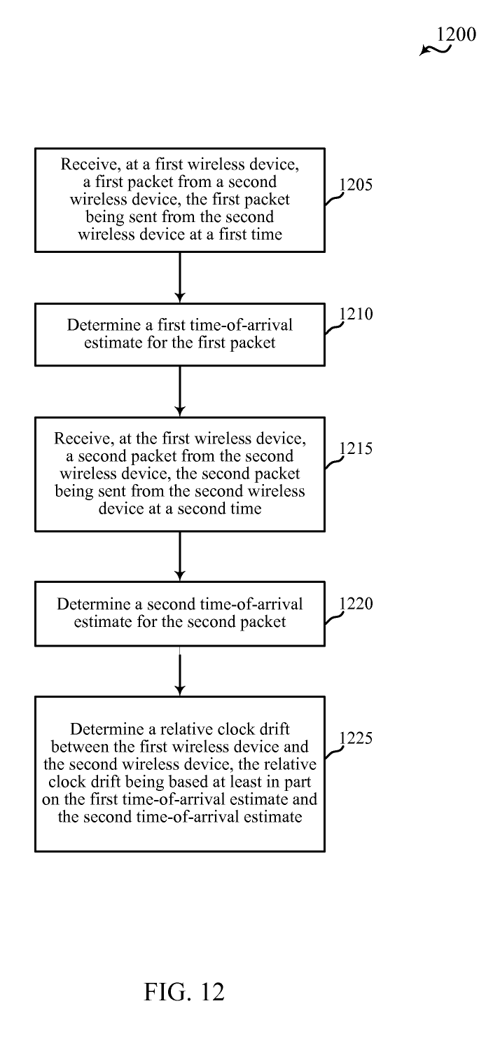

The components of the AP 105-d may implement aspects discussed above with respect to FIGS. 1-5, and those aspects may not be repeated here for the sake of brevity. Moreover, the components of the AP 105-d may implement aspects discussed below with respect to FIGS. 12-14 and those aspects may not be repeated here also for the sake of brevity.

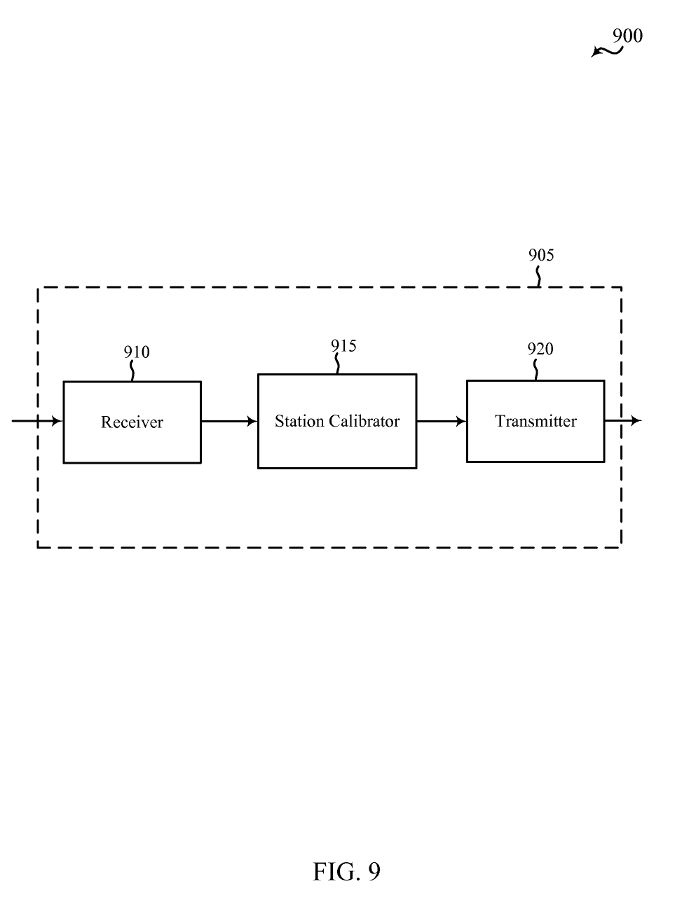

FIG. 9 shows a block diagram 900 of an apparatus 905 for use in a station for wireless communication, in accordance with various aspects of the present disclosure. In some examples, the apparatus 905 may be an example of aspects of the wireless devices 110 described with reference to FIGS. 1-6. The apparatus 905 may also be or include a processor. The apparatus 905 may include a receiver 910, a station calibrator 915, and/or a transmitter 920. Each of these modules may be in communication with each other.

The apparatus 905, through the receiver 910, the station calibrator 915, and/or the transmitter 920, may perform functions described herein. For example, the apparatus 905 may calibrate a clock of the apparatus 905. For example, the apparatus 905 may determine a relative clock drift between the apparatus 905 and another AP and/or wireless device.

The components of the apparatus 905 may, individually or collectively, be implemented using ASICs adapted to perform some or all of the applicable functions in hardware. Alternatively, the functions may be performed by other processing units (or cores), on integrated circuits. In other examples, other types of integrated circuits may be used (e.g., Structured/Platform ASICs, FPGAs, and other Semi-Custom ICs), which may be programmed in any manner known in the art. The functions of each component may also be implemented, in whole or in part, with instructions embodied in a memory, formatted to be executed by general or application-specific processors.

The receiver 910 may receive information such as packets, user data, and/or control information associated with various information channels (e.g., control channels, data channels, etc.). The receiver 910 may receive two or more identical data packets over the same channel and time-of-departure information related to the two data packets. The receiver 910 may also receive information related to an estimated relative clock drift. Information may be passed on to the station calibrator 915, and to other components of the apparatus 905.

The station calibrator 915 may receive timing information for two identical data packets received at the receiver 910, including time-of-departure. The station calibrator 915 may determine an estimated time-of-arrival for each data packet. The data packets may be sent from a same device, such as a wireless device 110. The station calibrator 915 may determine a relative clock drift between the apparatus 905 and the sending device. The station calibrator 915 may provide the determined relative clock drift to the transmitter 920.

The transmitter 920 may transmit the signals received from other components of the apparatus 905. The transmitter 920 may transmit a determined relative clock drift. In other examples, the transmitter 920 may transmit two or more identical data packets, each having a different time-of-departure, over a same frequency. In other examples, the transmitter 920 may transmit packets in a series of RTT exchanges. In some examples, the transmitter 920 may be collocated with the receiver 910 in a transceiver module. The transmitter 920 may include a single antenna, or it may include a plurality of antennas.

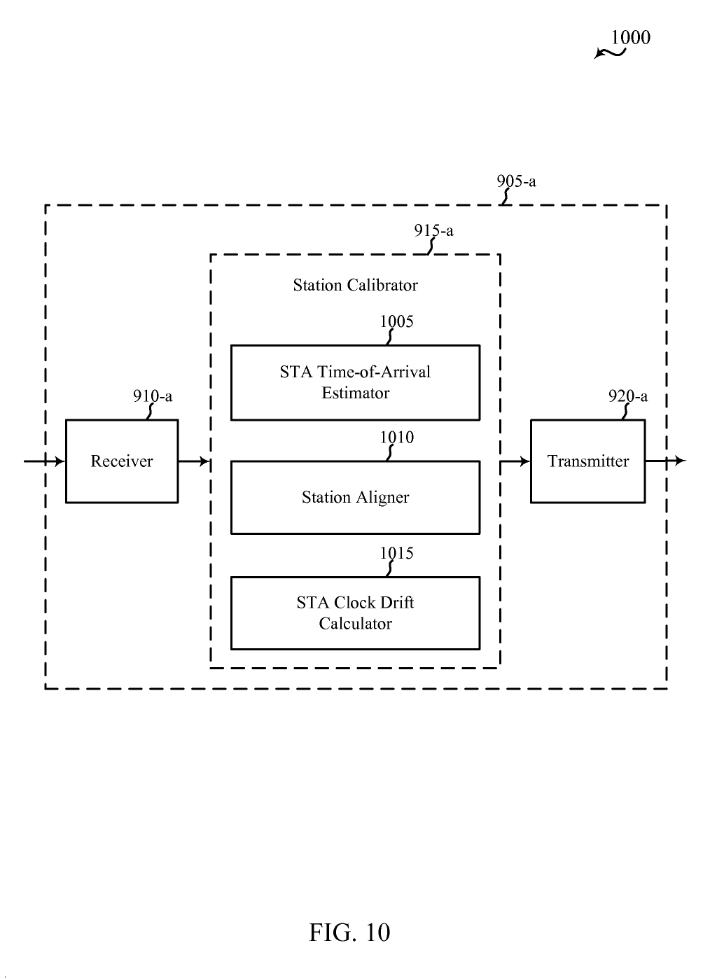

FIG. 10 shows a block diagram 1000 of an apparatus 905-a that is used in a wireless device for wireless communication, in accordance with various examples. The apparatus 905-a may be an example of aspects of a wireless device 110 described with reference to FIGS. 1-5. It may also be an example of an apparatus 905 described with reference to FIG. 9. The apparatus 905-a may include a receiver 910-a, a station calibrator 915-a, and/or a transmitter 920-a, which may be examples of the corresponding modules of apparatus 905. The apparatus 905-a may also include a processor. Each of these modules may be in communication with each other. The station calibrator 915-a may include a station time-of-arrival estimator 1005, a station aligner 1010, and/or a station clock drift calculator. The receiver 910-a and the transmitter 920-a may perform the functions of the receiver 910 and the transmitter 920, of FIG. 9, respectively.

The STA time-of-arrival estimator 1005 may estimate a time-of-arrival for each data packet received at the apparatus 905-a. In some examples, the STA time-of-arrival estimator 1005 only estimates the time-of-arrival for each data packet sent in a clock calibration process. For example, the STA time-of-arrival estimator 1005 may determine a first time-of-arrival estimate for the first packet and a second time-of-arrival estimate for the second packet.

The STA time aligner 1010 may align the estimated time-of-arrivals for the two data packets received at the receiver 910-a. That is, the STA time aligner 1010 may perform a time correlation between the first packet and the second packet. For example, the STA time aligner 1010 may perform a slope estimation between two different long training field symbols between the apparatus and the wireless device. The STA time aligner 1010 may align the first time-of-arrival estimate with the second time-of-arrival estimate using the time correlation and the slope estimation.

The STA clock drift calculator 1015 may determine a relative clock drift between the apparatus 905-a and the other wireless device based at least in part on the first time-of-arrival estimate and the second time-of-arrival estimate. In some examples, the wherein the STA clock drift calculator 1015 may determine the relative clock drift based at least in part on the first TOD and the second TOD.

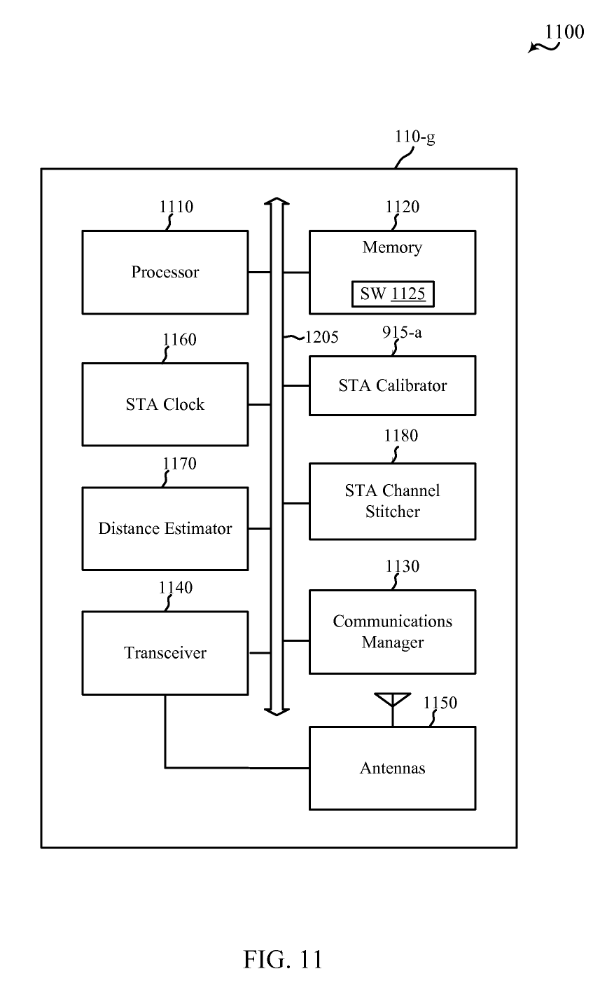

FIG. 11 shows a block diagram 1100 of a wireless device 110-g for use in wireless communication, in accordance with various aspects of the present disclosure The wireless device 110-g may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, etc. The wireless device 110-g may have an internal power supply, such as a small battery, to facilitate mobile operation. The wireless device 110-a may be an example of the wireless devices 110 of FIGS. 1-5.

The wireless device 110-g may include a processor 1110, a memory 1120, a transceiver 1140, antennas 1150, and a station calibrator 915-b. The station calibrator 915-b may be an example of the station calibrator 915 of FIGS. 9 and/or 10. Each of these modules may be in communication with each other, directly or indirectly, over at least one bus 1105. The wireless device 110-g may also include a station clock 1160 that measures times of departure and arrival of data packets. The wireless device 110-g may further include a distance estimator 1170 and a station channel stitcher 1180.

The memory 1120 may include RAM and ROM. The memory 1120 may store computer-readable, computer-executable software (SW) code 1125 containing instructions that, when executed, cause the processor 1110 to perform various functions described herein for clock drift calibration, distance estimation, and channel stitching. Alternatively, the software code 1125 may not be directly executable by the processor 1110 but may cause the computer (e.g., when compiled and executed) to perform functions described herein.

The processor 1110 may include an intelligent hardware device, e.g., a CPU, a microcontroller, an ASIC, etc. The processor 1110 may process information received through the transceiver 1140 and/or to be sent to the transceiver 1140 for transmission through the antennas 1150. The processor 1110 may handle, alone or in connection with the station calibrator 915-b, various aspects for determining clock drift calibrations and calibrating the station clock 1160.

The distance estimator 1170 may be used to determine a distance between the wireless device 110-g and another device, such as another wireless device 110 and/or an AP 105. The distance estimator 1170 may use values of time-of-departure and values of time-of-arrival for data packets, along with the estimated clock drift calibration to determine a physical distance between the wireless device 110-g and the other device.

The transceiver 1140 may communicate bi-directionally with APs 105 in FIGS. 1-3, 5, and/or 9. The transceiver 1140 may be implemented as at least one transmitter and at least one separate receiver. The transceiver 1140 may include a modem to modulate the packets and provide the modulated packets to the antennas 1150 for transmission, and to demodulate packets received from the antennas 1150. While the wireless device 110-g may include a single antenna, there may be aspects in which the wireless device 110-g may include multiple antennas 1150.

According to the architecture of FIG. 11, the wireless device 110-a may further include a communications manager 1130. The communications manager 1130 may manage communications with various access points. The communications manager 1130 may be a component of the wireless device 110-a in communication with some or all of the other components of the wireless device 110-a over the at least one bus 1105. Alternatively, functionality of the communications manager 1130 may be implemented as a component of the transceiver 1140, as a computer program product, and/or as at least one controller element of the processor 1110.

The components of the wireless device 110-a may implement aspects discussed above with respect to FIGS. 1-5, and those aspects may not be repeated here for the sake of brevity. Moreover, the components of the wireless device 110-a may implement aspects discussed below with respect to FIGS. 12-14, and those aspects may not be repeated here also for the sake of brevity.

FIG. 12 is a flow chart illustrating an example of a method 1200 for wireless communication, in accordance with various aspects of the present disclosure. For clarity, the method 1200 is described below with reference to aspects of the AP 105 described with reference to FIGS. 1-3, 5, and/or 6-8, and/or aspects of the wireless devices 110 described with reference to FIGS. 1-5 and/or 9-11. In some examples, an AP 105 or a wireless device 110 may execute sets of codes to control the functional elements of the AP 105 or the wireless device 110 to perform the functions described below. Additionally or alternatively, the AP 105 or the wireless device 110 may perform the functions described below using-purpose hardware.

At block 1205, the method 1200 may include receiving, at a first wireless device, a first packet from a second wireless device sent at a first time. The first packet may be, for example, the first packet 305 described in FIGS. 3 and/or 4. At block 1210, the method 1200 may include determining a first time-of-arrival estimate for the first packet. The first time-of-arrival estimate for the first packet may be a timestamp according to a clock of the first wireless device, when the receiver receives the first packet.

At block 1215, the method 1200 may include receiving, at the first wireless device, a second packet from a second wireless device sent at a second time. The second packet may be, for example, the second packet 320 described in FIGS. 3 and/or 4. At block 1220, the method 1200 may include determining a second time-of-arrival estimate for the second packet. The second time-of-arrival estimate for the second packet may be a timestamp according to a clock of the first wireless device, when the receiver receives the second packet. In some examples, the first packet and the second packet are received on a same frequency. The first packet and the second packet may be identical packets.

In some examples, the method 1200 may also include receiving, at the first wireless device, a first time-of-departure (TOD) for the first packet as determined by the second wireless device and receiving, at the first wireless device, a second TOD for the second packet as determined by the second wireless device.

At block 1225, the method 1200 may also include determining a relative clock drift between the first wireless device and the second wireless device based at least in part on the first time-of-arrival estimate and the second time-of-arrival estimate. In some examples, determining the relative clock drift is further based at least in part on the first TOD and the second TOD.

In additional examples, determining the relative clock drift further comprises aligning the first time-of-arrival estimate with the second time-of-arrival estimate. In some examples, aligning the first time-of-arrival estimate and the second time-of-arrival estimate further includes at least one of performing a time correlation between the first packet and the second packet and performing a slope estimation between two different long training field symbols between the first wireless device and the second wireless device.

Techniques described herein can also be extended to calibrating clocks of three or more devices. In an example where the relative clock drift is a first relative clock drift, the method 1200 may further include receiving, at the first wireless device, a third time-of-arrival estimate from a third wireless device, wherein the third time-of-arrival estimate is for the third wireless device receiving the first packet. The method 1200 may also include receiving, at the first wireless device, a fourth time-of-arrival estimate from the third wireless device, wherein the fourth time-of-arrival estimate is for the third wireless device receiving the second packet. Further, the method 1200 may also include determining a second relative clock drift between the first wireless device and the third wireless device based at least in part on the third time-of-arrival estimate and the fourth time-of-arrival estimate.

In some examples, the method 1200 includes transmitting, by the first wireless device, the relative clock drift to the second wireless device. This enables the second wireless device to calibrate its clock according to a clock of the first wireless device.

The method 1200 may further include performing, by the first wireless device, multiple RTT packet exchanges with the second wireless device over different channels of a bandwidth and determining channel frequency responses for each of the RTT packet exchanges. The method 1200 may further include stitching together the channel frequency responses and determining a bandwidth channel frequency response for the bandwidth based at least in part on the stitched channel frequency responses and the relative clock drift.

The method 1200 may further include determining a distance between the first wireless device and the second wireless device based at least in part on a transmission time of a data packet between the first wireless device and the second wireless device and the relative clock drift. Calibrating for the relative clock drift may improve any distance measurement made with the method 1200.

The operations at blocks 1205 and 1215 may be performed using the receiver 610 and/or the receiver 910 described with reference to FIGS. 6-11. The operations at blocks 1210, 1220, and 1225 may be performed using the AP calibrator 615 and/or the station calibrator 915 described with reference to FIGS. 6-11.

Thus, the method 1200 may provide for wireless communication. It should be noted that the method 1200 is just one implementation and that the operations of the method 1200 may be rearranged or otherwise modified such that other implementations are possible.

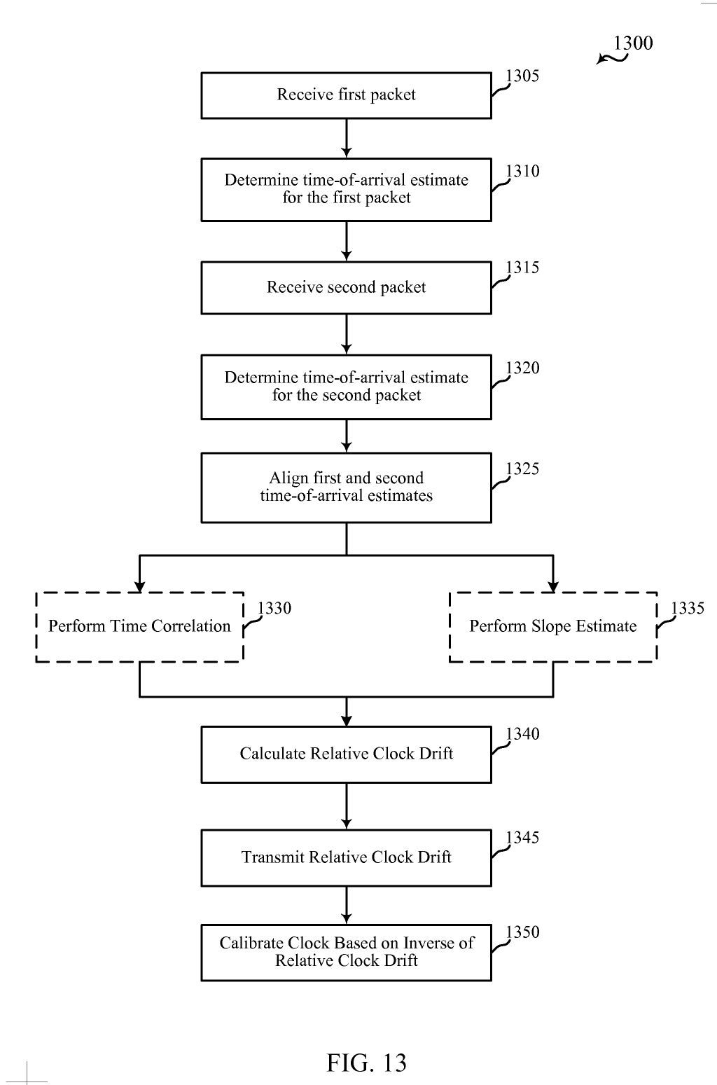

FIG. 13 is a flowchart of a method 1300 for clock calibration using information for received data packets, in accordance with various aspects of the present disclosure. For clarity, the method 1300 is described below with reference to aspects of the AP 105 described with reference to FIGS. 1-3, 5, and/or 6-8, and/or aspects of the wireless devices 110 described with reference to FIGS. 1-5 and/or 9-11. In some examples, an AP 105 or a wireless device 110 may execute sets of codes to control the functional elements of the AP 105 or the wireless device 110 to perform the functions described below. Additionally or alternatively, the AP 105 or the wireless device 110 may perform the functions described below using-purpose hardware.

The wireless device (e.g., a wireless device 110 or an AP 105) may receive a first packet at block 1305. The wireless device may receive the first packet on a channel from another wireless device (e.g., another wireless device 110 or AP 105). The wireless device determines a time-of-arrival estimate for the first packet at block 1310. The wireless device may receive a first packet at block 1305. The wireless device may receive the second packet on the same channel from the other wireless device. The wireless device determines a time-of-arrival estimate for the first packet.

At block 1325, the method 1300 may include aligning the first and second time-of-arrival estimates. One example of the method 1300 includes performing a time correlation at block 1330 to align the first and second TOA estimates. Alternatively, the method 1300 may include performing a slope estimate to align the first and second TOA estimates at block 1335. In some examples, the method 1300 may include both alignment options. In such an example, the method 1300 may average the results of the alignment between the two options, or provide some other weighted combination of the results.

Once the method 1300 has determined an alignment of the TOA estimates, the method 1300 may include calculating a relative clock drift at block 1340. The relative clock drift may be determined according to techniques described above with respect to FIGS. 1-5 and 12, and those aspects may not be repeated here for the sake of brevity. The method 1300 may include transmitting the relative clock drift to the other wireless device at block 1345. The method 1300 may also include calibrating the clock of the wireless device based on an inverse of the relative clock drift.

The operations at blocks 1305 and 1315 may be performed using the receiver 610 and/or the receiver 910 described with reference to FIGS. 6-11. The operations at blocks 1310, 1320, 1325, 1330, 1335, 1340, and/or 1350 may be performed using the AP calibrator 615 and/or the station calibrator 915 described with reference to FIGS. 6-11. The operations at block 1345 may be performed using the transmitter 620 and/or the transmitter 920 described with reference to FIGS. 6-11.

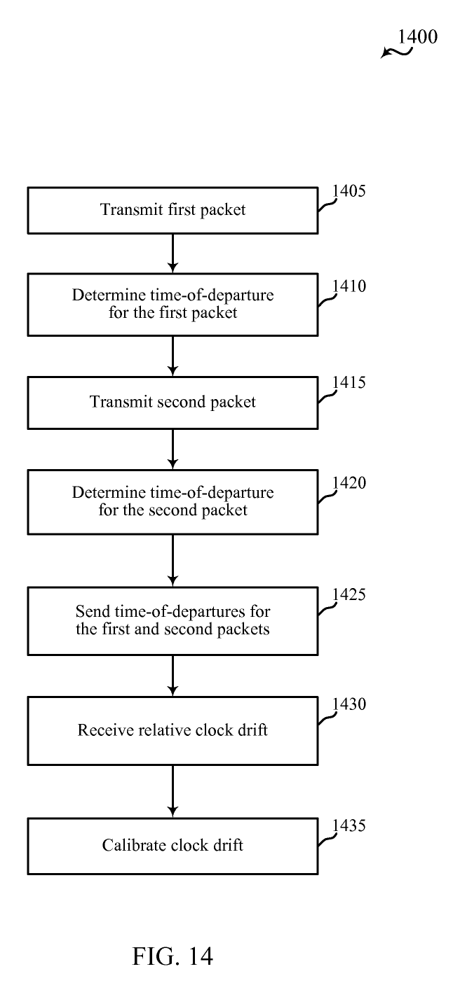

FIG. 14 is a flowchart of a method for clock calibration for a wireless device that sent data packets, in accordance with various aspects of the present disclosure. For clarity, the method 1400 is described below with reference to aspects of the AP 105 described with reference to FIGS. 1-3, 5, and/or 6-8, and/or aspects of the wireless devices 110 described with reference to FIGS. 1-5 and/or 9-11. In some examples, an AP 105 or a wireless device 110 may execute sets of codes to control the functional elements of the AP 105 or the wireless device 110 to perform the functions described below. Additionally or alternatively, the AP 105 or the wireless device 110 may perform the functions described below using-purpose hardware.

At block 1405, the method 1400 may include transmitting a first packet. The method 1400 may determine a time-of-departure for the first packet at block 1410. In some examples, the time-of-departure can be determined when the transmitter, such as the transmitter 620 and/or the transmitter 920 described with reference to FIGS. 6-11, sends the first packet. At block 1415, the method 1400 may include transmitting a second packet. The method 1400 may determine a time-of-departure for the second packet at block 1420. In some examples, the time-of-departure can be determined when the transmitter sends the second packet. The method 1400 may transmit the first and second packets on a same channel to a same wireless device, such as an AP or station. In some examples, the first and second packets may have almost identical content.

At block 1425, the method 1400 may include transmitting the TODs for the first and the second packets. In some examples, information related to the TODs for the first and the second packets may be transmitted along with the first and second packets, respectively.

The method 1400 may also include receiving a relative clock drift at block 1430. The relative clock drift may be determined by the device that received the first and second packets. The method 1400 may further include calibrating a clock of the wireless device according to the relative clock drift.

The operations at blocks 1405, 1415, and 1425 may be performed using the transmitter 620 and/or the transmitter 920 described with reference to FIGS. 6-11. The operations at blocks 1410, 1420, and 1435 may be performed using the AP calibrator 615 and/or the station calibrator 915 described with reference to FIGS. 6-11. The operations at block 1430 may be performed using the transmitter 620 and/or the transmitter 920 described with reference to FIGS. 6-11.

In some examples, aspects from two or more of the methods 1200, 1300, and/or 1400 may be combined. It should be noted that the methods 1200, 1300, and/or 1400 are just example implementations, and that the operations of the methods 1200-1400 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection can be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
receiving, at a first wireless device, a first packet from a second wireless device sent at a first time;
determining a first time-of-arrival estimate for the first packet;
receiving, at the first wireless device, a second packet from the second wireless device sent at a second time;
determining a second time-of-arrival estimate for the second packet; and
determining a relative clock drift between the first wireless device and the second wireless device based at least in part on the first time-of-arrival estimate and the second time-of-arrival estimate.

2. The method of claim 1, further comprising:
transmitting, by the first wireless device, the relative clock drift to the second wireless device.

3. The method of claim 1, further comprising:
receiving, at the first wireless device, a first time-of-departure (TOD) for the first packet as determined by the second wireless device; and
receiving, at the first wireless device, a second TOD for the second packet as determined by the second wireless device,
wherein determining the relative clock drift is further based at least in part on the first TOD and the second TOD.

4. The method of claim 1, wherein determining the relative clock drift further comprises:
aligning the first time-of-arrival estimate with the second time-of-arrival estimate.

5. The method of claim 4, wherein aligning the first time-of-arrival estimate and the second time-of-arrival estimate further comprises at least one of:
performing a time correlation between the first packet and the second packet, and
performing a slope estimation between two different long training field symbols between the first wireless device and the second wireless device.

6. The method of claim 1, further comprising:
performing, by the first wireless device, multiple round trip time (RTT) packet exchanges with the second wireless device over different channels of a bandwidth; and
determining channel frequency responses for each of the RTT packet exchanges.

7. The method of claim 6, further comprising:
stitching together the channel frequency responses; and
determining a bandwidth channel frequency response for the bandwidth based at least in part on the stitched channel frequency responses and the relative clock drift.

8. The method of claim 1, further comprising:
determining a distance between the first wireless device and the second wireless device based at least in part on a transmission time of a data packet between the first wireless device and the second wireless device and the relative clock drift.

9. The method of claim 1, wherein the first packet and the second packet are received on a same frequency.

10. The method of claim 1, wherein the relative clock drift is a first relative clock drift, further comprising:
receiving, at the first wireless device, a third time-of-arrival estimate from a third wireless device, wherein the third time-of-arrival estimate is for the third wireless device receiving the first packet;
receiving, at the first wireless device, a fourth time-of-arrival estimate from the third wireless device, wherein the fourth time-of-arrival estimate is for the third wireless device receiving the second packet; and
determining a second relative clock drift between the first wireless device and the third wireless device based at least in part on the third time-of-arrival estimate and the fourth time-of-arrival estimate.

11. The method of claim 10, further comprising:
calibrating a clock difference between the second wireless device and the third wireless device based at least in part on the second relative clock drift and the first relative clock drift.

12. The method of claim 1, wherein the first wireless device is limited to a maximum bandwidth.

13. An apparatus for wireless communication, comprising:
means for receiving, at a first wireless device, a first packet from a second wireless device sent at a first time;
means for determining a first time-of-arrival estimate for the first packet;
means for receiving, at the first wireless device, a second packet from the second wireless device sent at a second time;
means for determining a second time-of-arrival estimate for the second packet; and
means for determining a relative clock drift between the first wireless device and the second wireless device based at least in part on the first time-of-arrival estimate and the second time-of-arrival estimate.

14. The apparatus of claim 13, further comprising:
means for transmitting, by the first wireless device, the relative clock drift to the second wireless device.

15. The apparatus of claim 13, further comprising:
means for receiving, at the first wireless device, a first time-of-departure (TOD) for the first packet as determined by the second wireless device; and
means for receiving, at the first wireless device, a second TOD for the second packet as determined by the second wireless device,
wherein means for determining the relative clock drift is further based at least in part on the first TOD and the second TOD.

16. The apparatus of claim 13, wherein means for determining the relative clock drift further comprises:
means for aligning the first time-of-arrival estimate with the second time-of-arrival estimate.

17. The apparatus of claim 1, further comprising:
means for performing, by the first wireless device, multiple round trip time (RTT) packet exchanges with the second wireless device over different channels of a bandwidth; and
means for determining channel frequency responses for each of the RTT packet exchanges.

18. The apparatus of claim 6, further comprising:
means for stitching together the channel frequency responses; and
determining a bandwidth channel frequency response for the bandwidth based at least in part on the stitched channel frequency responses and the relative clock drift.

19. The apparatus of claim 1, further comprising:
means for determining a distance between the first wireless device and the second wireless device based at least in part on a transmission time of a data packet between the first wireless device and the second wireless device and the relative clock drift.

20. The apparatus of claim 1, wherein the relative clock drift is a first relative clock drift, further comprising:
means for receiving, at the first wireless device, a third time-of-arrival estimate from a third wireless device, wherein the third time-of-arrival estimate is for the third wireless device receiving the first packet;
means for receiving, at the first wireless device, a fourth time-of-arrival estimate from the third wireless device, wherein the fourth time-of-arrival estimate is for the third wireless device receiving the second packet; and
means for determining a second relative clock drift between the first wireless device and the third wireless device based at least in part on the third time-of-arrival estimate and the fourth time-of-arrival estimate.

21. An apparatus for wireless communication, comprising:
a receiver to receive a first packet from a wireless device sent at a first time and a second packet from the wireless device sent at a second time;
a time-of-arrival estimator to determine a first time-of-arrival estimate for the first packet and a second time-of-arrival estimate for the second packet;
a calibrator to determine a relative clock drift between the first wireless device and the second wireless device based at least in part on the first time-of-arrival estimate and the second time-of-arrival estimate.

22. The apparatus of claim 21, wherein the transmitter is further configured to:
transmit the relative clock drift to the wireless device.

23. The apparatus of claim 21, wherein the receiver is further configured to:
receive a first time-of-departure (TOD) for the first packet as determined by the wireless device; and
receive a second TOD for the second packet as determined by the wireless device,
wherein the calibrator is further configured to determine the relative clock drift further comprises the calibrator to determine the relative clock drift based at least in part on the first TOD and the second TOD.

24. The apparatus of claim 21, wherein the calibrator is further configured to:
perform at least one of a time correlation between the first packet and the second packet or a slope estimation between two different long training field symbols between the apparatus and the wireless device, and an alignment of the first time-of-arrival estimate with the second time-of-arrival estimate using the time correlation or the slope estimation.

25. The apparatus of claim 21, wherein the receiver is further configured to receive multiple received round trip time (RTT) packets from the wireless device over different channels of a bandwidth, wherein transmitter is further configured to multiple transmitted RTT packets to the wireless device over the different channels, the apparatus further comprising:
a channel stitcher to determine channel frequency responses for at least some of the RTT packets, stitch together the channel frequency responses, and determine a bandwidth channel frequency response for the bandwidth based at least in part on the stitched channel frequency responses and the relative clock drift.

26. The apparatus of claim 21, further comprising:
a distance estimator to determine a distance between the apparatus and the wireless device based at least in part on a transmission time of a data packet between the apparatus and the wireless device and the relative clock drift.

27. A non-transitory computer-readable medium storing computer-executable code for wireless communication, the code executable by a processor to:
receive, at a first wireless device, a first packet from a second wireless device sent at a first time;
determine a first time-of-arrival estimate for the first packet;
receive, at the first wireless device, a second packet from the second wireless device sent at a second time;
determine a second time-of-arrival estimate for the second packet; and
determine a relative clock drift between the first wireless device and the second wireless device based at least in part on the first time-of-arrival estimate and the second time-of-arrival estimate.

28. The non-transitory computer-readable medium of claim 27, the code further executable by the processor to:
receive, at the first wireless device, a first time-of-departure (TOD) for the first packet as determined by the second wireless device; and
receive, at the first wireless device, a second TOD for the second packet as determined by the second wireless device,
wherein determine the relative clock drift is further based at least in part on the first TOD and the second TOD.

29. The non-transitory computer-readable medium of claim 27, the code further executable by the processor to:
align the first time-of-arrival estimate with the second time-of-arrival estimate.

30. The non-transitory computer-readable medium of claim 27, the code further executable by the processor to:
perform multiple round trip time (RTT) packet exchanges with the second wireless device over different channels of a bandwidth; and
determine channel frequency responses for each of the RTT packet exchanges;
stitch together the channel frequency responses; and
determine a bandwidth channel frequency response for the bandwidth based at least in part on the stitched channel frequency responses and the relative clock drift.
